(19) United States
(12) Patent Application Publication
(10) Pub. No.: US 2012/0315412 A1
(43) Pub. Date: Dec. 13, 2012

(54) Scented Thermochromic Ink

(76) Inventors: Terrill Scott Clayton, Colorado Springs, CO (US); Timothy J. Owen, Colorado Springs, CO (US)

(21) Appl. No.: 13/470,852

(22) Filed: May 14, 2012

Related U.S. Application Data
(60) Provisional application No. 61/485,804, filed on May 13, 2011.

(51) Int. Cl. C09D 161/28; C08K 5/09; C09D 11/02; C09D 161/24; C09D 127/18; C09D 163/00; B32B 1/02; C09D 135/02

(52) U.S. Cl. 428/34.1; 524/300; 523/427; 523/400

(57) ABSTRACT

A thermochromic ink contains scented microcapsules.

### RELATED APPLICATIONS

This Application claims the benefit or priority of Provisional Application Ser. No. 61/485,804 filed May 13, 2011, incorporated herein by reference in its entirety.

### BACKGROUND

### Thermochromic Inks

Thermochromic and photochromic encapsulated dyes undergo a color change over a specific temperature range. By way of example, a dye may change from a particular color at low temperature to colorless at a high temperature, such as red at 85° F. and colorless at above 90° F. The color change temperature is controllable, such that the color-change can take place at different temperatures. In one example, the color change may occur at a temperature just below a person's external body temperature so that a color change occurs in response to a human touch.

This variability in the dyes results from selected materials and manufacturing processes. One technique used to produce the thermochromic encapsulated dye is to combine water, dye, oil, with melamine formaldehyde resin and agitate to create a very fine emulsification. Interfacial tensions are such that the oil and dye end up on the inside of a melamine formaldehyde capsule distributed in primarily the water phase. The melamine formaldehyde substance, while very hard and resistant to breakdown at high temperature, is permeable. A variety of thermochromic inks may be purchased on commercial order, for example, from Chromatic Technologies, Inc. of Colorado Springs, Colo.

U.S. Pat. Nos. 4,421,560 and 4,425,161 entitled “Thermochromic Materials” both state that thermochromic inks can be made with “conventional additives used to improve conventional printing inks.” Nonetheless, there are concerns over what additives may be added to these inks.

U.S. Pat. No. 6,139,779 teaches that it is desirable to minimize the use of certain solvents and other compounds that degrade or destroy the color performance of the dye. In particular, aldehydes, ketones, and diols should be removed from the formulation and replaced with solvents that do not adversely affect the thermochromic pigment. In this regard, solvents having a large molecular weight (i.e. greater than 100) generally are compatible with the thermochromic pigments. The acid content of the formulation may also be adjusted to a value of less than 20 or adjusted to be neutral in the range from 6.5-7.5 pH. These adjustments allow the thermochromic dyes to be added to the formulation without a loss of its color change properties.

Thermochromic dye is often sold in a slurry of encapsulated dye in a water base. It happens that the pH of this slurry is most often neutral in a range from 6.5 to 7.5. When thermochromic dye is added to a formulation that has a pH outside this range, the color change properties are often always lost. This is an irreversible effect and therefore, it is important to adjust the pH prior to adding the thermochromic dye.

Several types of ingredients are traditionally added to ink formulations. The combination of all the ingredients in an ink, other than the pigment, is called the vehicle. The vehicle carries the pigment to the substrate and binds the pigment to the substrate. The correct combination of vehicle ingredients will result in the wetting of an ink. This wetting means that the vehicle forms an absorbed film around the pigment particles. The main ingredient in an ink is the binder. This may be a resin, lacquer or varnish or some other polymer. The binder characteristics vary depending on the type of printing that is being done and the desired final product. The second main ingredient is the colorant itself, for example, as described above. The remaining ingredients are added to enhance the color and printing characteristics of the binder and the colorant. These remaining ingredients may include reducers (solvents), waxes, surfactant, thickeners, driers, and/or UV inhibitors.

### Scented Inks

As taught by U.S. Pat. No. 6,454,842, scented inks may be produced using microcapsules to prolong the life of the scent. These scented inks do not use thermochromic materials and may be microencapsulated using an microemulsion that contains a water soluble polymer selected from the group consisting of acrylic, styrenated maleic anhydride, sulfonated polyester, polyamide, and polyurethane or monomers thereof; (ii) a colorant; (iii) water and (iv) scented oil.

Perfumes and other scented materials generally contain ketones and aldehydes that contribute significantly to the scent. Diols, such as glycerol, may be used as solvents. This presents a materials incompatibility issue where these materials are known to degrade the performance of thermochromic dyes. It does not appear that perfumes are used as an ingredient in thermochromic inks

### Metal Deco Applications

Lithography depends upon the separation of oil and water. The oil is the ink and the water is the fountain solution. The fountain solution is acidic to minimize the emulsification of ink. The higher the pH the more scumming occurs; i.e. the movement of ink into areas of the image that are supposed to by free of ink. The acid and other components in fountain solutions destroy the color change characteristics of the thermochromic pigments.

The use of thermochromic inks for metal decoration is an area of special concern. Most metal beverage cans made in the United States are manufactured from aluminum. In Europe and Asia, approximately 55 percent of cans are made of steel and 45 percent are aluminum alloy. Aluminum cans may contain an internal coating to protect the aluminum from beverage corrosion. Chemical compounds used in the internal coating of the can include types of epoxy resin.

Beverage cans are usually filled before the top is crimped in place. The filling and sealing operations are fast and precise. The filling head centers over the can and discharges the beverage to flow down the sides of the can. The lid is placed on the can then crimped in two operations. A seaming head engages the lid from above while a seaming roller to the side curls the edge of the lid around the edge of the can body. The head and roller spin the can in a complete circle to seal all the way around. A pressure roller next drives the two edges together under pressure to make a gas-tight seal. Filled cans usually have pressurized gas inside, which stiffens the filled cans for subsequent handling.

Aluminum cans may be produced through a mechanical cold forming process starting with punching a flat blank from very stiff cold-rolled sheet. This sheet is often made of a material called alloy 3104-H19 or 3004-H19. This material is aluminum with about 1% manganese and 1% magnesium for strength and formability. A flat blank is first formed into a cup about three inches in diameter. This cup is then pushed through a forming process called “ironing” which forms the can. The bottom of the can is also shaped at this time. The malleable metal deforms into the shape of an open-top can.

Plain lids are stamped from a coil of aluminum, typically alloy 5182-H48, and transferred to another press that converts the stamped materials into easy-open ends. The conversion press forms an integral rivet button in the lid and scores the opening, while concurrently forming the tabs in another die from a separate strip of aluminum. The tab is pushed over the button, which is then flattened to form the rivet that attaches the tab to the lid. The top rim of the can is trimmed and pressed inward or “necked” to form a taper conical where the can will later be filled and the lid (usually made of an aluminum alloy with magnesium) attached. The lid components, especially the tabs, may be coated before they are subjected to such manufacturing processes as riveting.

Exterior surfaces of the cans may be coated with inks as shown, by way of example, in U.S. Pat. No. 6,494,950. Polyester resins are often favored for use on the sides of the cans. Epoxy resins are favored for use on the lids, especially where there is a need for improved durability of the coatings. Thermochromic inks may be used as indicators to assess when beverages have reached a particular temperature, such as when a soft drink or a beer is at a temperature that is particularly pleasing to the palate. A variety of polyester-based thermochromic inks are commercially available for coating the sides of the cans. Practically speaking, epoxy-based thermochromic inks are not widely available.

### SUMMARY

The present disclosure overcomes the problems outlined above and advances the art by providing scented thermochromic coatings.

In one embodiment, these coatings may be used may be used as temperature indicators on the beverage cans, for example, in coating the pull tab on a beverage can that indicates suitable cooling of the beverage while enhancing the organoleptic quality of the beverage by providing a compatible scent. For example, a light beer that may be enjoyed with a wedge of lime or other citrus may be provided with a tab indicating the beer is suitable cooled for consumption and which also provides a lime or citrus scent.

Ink embodiments for may contain, in combination, a conventional vehicle, scented microcapsules, and thermochromic microcapsules. The thermochromic microcapsules are preferably present in an amount ranging from 1% to 30% of the coating by weight on a sliding scale. This means that there may be from 1% to 30% if the thermochromic microcapsules and from 30% to 1% of the scented microcapsules. The vehicle contains a solvent is preferably present in an amount ranging from 25% to 75% by weight of the coating, and is most preferably about 50% by weight. The solvent is most preferably xylene.

In one embodiment, the scented microcapsules are preferably free of thermochromic dye. The microcapsules may otherwise be made of conventional melamine-formaldehyde materials substituting a scented material, especially a scented oil, for thermochromic dye. The scented microcapsules may then be mixed and used compatibly with melamine formaldehyde microcapsules that contain thermochromic dye.

### BRIEF DESCRIPTION OF THE DRAWINGS

FIG. 1 compares beverage cans that are coated with a scented thermochromic coating according to the present disclosure and chilled to different temperatures.

FIG. 2 shows a beverage can that is printed with a scented thermochromic ink to provide an indicator showing an approximate liquid level inside the beverage can.

### DETAILED DESCRIPTION

The relative interfacial tensions in a melamine formaldehyde microencapsulation system are such that water typically constitutes a continuous phase generally separating melamine-formaldehyde micelles. These micelles are special because, before it hardens, the melamine-formaldehyde resin encapsulates a core material. This core material may include a thermochromic system, such as a leuco dye and developer mixed with a nonaqueous solvent, as is well known in the prior art. According to the presently disclosed embodiments, the core material may alternatively be a scenting agent, such as a scented oil or perfume, to make scented microcapsules that do not contain a thermochromic system. These scented microcapsules may be then mixed (in dry or slurry form) with microcapsules that contain a thermochromic system to make a scented thermochromic ink.

Where the scenting agent does not contain appreciable amounts of aldehydes, ketones, and diols, the scenting agent may be mixed directly with the thermochromic system where the combined materials exist compatibly in the core of the microcapsules.

### Thermochromic Deactivating Agents

As compared to thermochromic microcapsules, scented microcapsules themselves are relatively insensitive to thermochromic deactivating materials including aldehydes, ketones, and diols. Nonetheless, these materials may permeate to exit the microcapsules and enter into thermochromic microcapsules where they may impair the performance of the thermochromic system in embodiments that combine thermochromic microcapsules with scented microcapsules. While it is permissible that the scented thermochromic ink may contain some of thermochromic deactivating materials in the core material of scented microcapsules, these materials in combination should not make up more than about 30% total weight of the scented thermochromic ink.

### Solvents

Solvents for diluting the scenting agent in the core material may suitably include those having low reactivity, large molecular weight (i.e. over 100), and which are relatively non-polar. One solvent that fits this category is cyclohexane, which has low toxicity and works well.

### Adjusting the Acid Content

Again, scented microcapsules, i.e., those having a scenting agent with essentially no thermochromic system components, are less sensitive to acid content than are microcapsules that contain a thermochromic system. Whenever the scented microcapsules will be mixed with thermochromic microcapsules, the component that contains the scented microcapsules should not cause the mixture pH to fall outside the range of 6.5 to 7.5. The pH adjustment may be performed as needed using a proton donor or acceptor, depending on whether the pH must be adjusted up or down. For example, HCl is used to lower the pH. KOH may be used to lower the pH. While pH tolerance sometimes exists in an expanded range between 6.0 and 8.0. A pH below 6.0 and above 8.0 almost always immediately destroys the thermochromic system in an irreversible manner.

In addition to pH, the acid value may also be considered. The acid value is defined as the number of milligrams of a 0.1 N KOH solution required to neutralize the alkali reactive groups in 1 gram of material under the conditions of ASTM Test Method D-1639-70. High acid number substances have inactivated the thermochromic pigments. Generally, the lower the acid number the better. Ink formulations with an acid value below 20 and not including the harmful solvents described above generally work well without deactivating the thermochromic system. Some higher acid value formulations may be possible but generally it is best to use vehicle ingredients with low acid numbers or to adjust the acid value by adding a an alkali substance. The greatest benefit of a neutral or low acid value vehicle is increased shelf life.

Buffers may be used to minimize the effects of the fountain solution on pigment particles. This is one possible solution to the potential acidity problem of the varnishes. One ingredient often used as a buffer is cream of tartar. A dispersion of cream of tartar and linseed oil can be incorporated into the ink. The net effect is that the pigments in the ink are protected from the acidic fountain solution.

### Mixing

The thermochromic inks are sold in two ways: 1) as a dry powder and 2) in a water based slurry. Conventional mixing systems exists for both slurry and powder that will allow for consistent and well dispersed pigment, and these may be purchased on commercial order.

### Drying Technique

The aqueous slurry can be used to make solvent-based ink formulations by first drying the slurry. In traditional ink manufacturing, there is a technique known as flushing. Many traditional pigments come in slurry form, similar to that of the thermochromic capsules. “Flushing” in traditional manufacturing, means to press most of the water out of the slurry to form what is called a press cake which is then “flushed” into a mixing varnish. The press cake is about 25-40% solids. Because of the hydrophobic properties of the pigment and the varnish, the pigment is mixed into the varnish and away from the water. The water separates from the varnish and is left behind. Flushing with the thermochromic capsules does not work. All of the water stays in the varnish rather than separating.

The slurry is placed in a forced air dryer, where the temperature is maintained at between 100 and 150 degrees F. When the slurry reaches the “stiff clay” stage, at about 80% to 95% solids, the slurry is removed and incorporated into a varnish. The varnish is mixed until smooth and the remaining ingredients are than added to this mixture. This mixture is then put over the mill between one and fifteen times, making the final product. In inks made with a “press cake” having 80 to 95 percent solids, the water does not alter the properties of the ink too severely.

This mixing technique achieves good dispersion and much improved color intensity over using completely dried thermochromic capsules. Not only is it difficult to get the dried capsules to disperse appropriately, but the drying process may destroy between 10% and 30% of the colorant.

### Ultrasound Technique

Microcapsules that have been dried all the way to the consistency of powder are difficult to disperse. The microcapsules tend to aggregate. Too much physical agitation by stirring may damage or denature the dye. The problem may be addressed by adding a solvent to the powder to achieve at least about 50% solids content. Once the solvent and the powder are combined, the container with the mixture is submerged in an ultrasound bath. The vibration breaks up the aggregates and conditions the capsules for addition of the remainder of the vehicle ingredients.

### General Procedures for Mixing Formulations

For the applications discussed herein, the technique is essentially that of adding pigment to different media to attain a desired result; that of mimicking the visual appearance of normal pigments while trying to add the dimension of thermal activity to its properties.

In order to add normal pigment to ink, dye, or lacquer, the pigment itself is ground into the base. This disperses the pigment throughout the base. Since the pigment is usually a solid crystal with a diameter no larger than 1.0 microns this grinding is not difficult to do. The eye cannot see particles that size, so the pigment will give the base a solid color. The addition of more pigment simply intensifies the color. Since the pigment has a very intense color only about 10% of the final ink is made up of normal pigments. Also, the normal pigment itself is relatively impervious to the effects of solvent and pH.

Others have used thermochromic dyes, however, these attempts have focused simply on the addition of thermochromic capsules to an ink base at random and observing whether or not the capsules maintain their original color-changing properties.

In general, the present disclosure teaches the following procedure for making formulations with thermochromic dyes. If in slurry form, and is intended for addition to a water base ink, the water is removed to give slurry between 80% and 95% solids. This is then mixed with an appropriate ink vehicle and milled.

A base for an ink is developed using off the shelf ingredients. The ink will incorporate, where possible, and compatible with the ink types, solvents with molecular weights larger than 100 and avoid all aldehydes, diols, and ketones, and aromatic compounds. Selection of the ingredients is critical. The important considerations with respect to the ingredients within the ink vehicle deal with the reactivity of these ingredients with the thermochromic capsule and its contents.

Ketones, diols, and aldehyde content is minimized, as well as most mineral spirits, excluding cyclohexane and other chemically similar compounds. Ammonia, and other highly reactive compounds are also avoided. The lower the amounts of these compounds, the better the performance of the thermochromic and the longer the shelf life of the product.

Cyclohexane is effective for the purposes of dispersion of the dry thermochromic powder, or for the cleaning of the press in preparation for printing the thermochromic ink. There are however several other possible options for cleaning or as reducers within the ink itself that will also be effective.

The pH or acid value of the ink base is adjusted before the pigment is added. This can be done by ensuring that each individual component of the base is at the correct pH or acid value or by simply adding a proton donor or proton acceptor to the base itself prior to adding the pigment. The appropriate specific pH is generally neutral, or 7.0. The pH will vary between 6.0 and 8.0 depending on the ink type and the color and batch of the pigment.

Once the slurry and the base have been properly prepared, they are combined. The method of stirring should be low speed with non-metal stir blades. An ink mill may be used so long as the mill pressure is set low enough to avoid harming the microcapsules. Other additives may be incorporated to keep the pigment suspended. The ink should be stored at room temperature.

Most thermochromic dyes undergo a color change from a specific color to colorless (i.e. clear). Therefore, layers of background colors can be provided under thermochromic layers that will only be seen when the thermochromic layer changes to colorless. If an undercoat of yellow is applied to the substrate and then a layer containing blue thermochromic dye is applied the color will appear to change from green to yellow, when what is really happening is that the blue is changing to colorless.

### The Substrate

All substrates that are made-ready to receive the ink should be approximately neutral in pH, and should not impart any chemicals to the capsule that will have a deleterious effect on it. Many types of paper have relatively low pH that could impact the thermochromic capsules. Low pH could cause serious deterioration in a matter of weeks. If quality control is to be maintained, this aspect of the chemistry should be taken into consideration. Use neutral paper whenever possible. Other substrates may include metal, such as aluminum or steel, glass, plastic, fabric, wood, and other substrates.

### Specific Formulations

Specific formulations of thermochromic dye formulations are provided below using the principles and techniques taught above. These embodiments teach by way of specific example, and not by limitation.

Production of scented microcapsules may be performed as reported in U.S. Pat. No. 7,901,772, which is incorporated by reference to the same extent as though fully replicated herein.

### Example 1

### Production of Melamine Resin Membrane/Fragrance Microcapsules (in situ polymerization method)

Step A. Preparation of encapsulation core material (mixture): A mixture comprising 75% of a mint fragrance (X-7028, manufactured by Takasago International Corporation, this also applies to all subsequent references to mint) and 25% of palmitic acid (melting point: 63° C.) is stirred at 70° C., thereby dissolving the palmitic acid in the fragrance. The melting point range (T1-T2) for the resulting mixture is from 5 to 45° C. (confirmed visually). The mixture is held at 55° C. to prevent it solidifying prior to emulsification.

Step B. Preparation of emulsion accelerator liquid: 15% of ethylene maleic anhydride resin (Scripset-520, manufactured by Monsanto Company) and 85% of water are mixed together at 60° C., and the mixture is adjusted to pH 4 using acetic acid.

Step C. Preparation of aqueous solution of melamine resin prepolymer: 15% of a melamine-formaldehyde resin (Sumirez Resin 615K, manufactured by Sumitomo Chemical Co., Ltd.) is dissolved in 85% of water at 60° C.

Step D Capsulation: 100 parts of the above emulsion accelerator liquid from Step B is stirred at 60° C. at 3,000 rpm using a TK Homomixer Mark II 20 (manufactured by Tokushu Kika Kogyo Co., Ltd.), 100 parts of the above encapsulation material from Step A is added and emulsified, the rotational speed is then gradually raised, and stirring is conducted at 7,000 rpm for 30 minutes, yielding an emulsion in which the average particle size of the oil droplets of the encapsulation material is approximately 3 μm (as measured by a laser diffraction particle size analyzer SALD-3100 (manufactured by Shimadzu Corporation). This analyzer is also used to measure all subsequent particle sizes.

To this emulsion is added 50 parts of the above melamine resin prepolymer aqueous solution from Step C. Stirring is continued for 2 hours, thus generating a melamine resin membrane around the periphery of the encapsulation material, and forming a microcapsule slurry with a solid fraction concentration of approximately 40%.

### Example 2

### Production of Melamine Resin Membrane/Fragrance Microcapsules (in situ Polymerization Method)

An encapsulation material (A) is prepared by mixing 75% of the mint fragrance and 25% of behenyl alcohol (melting point: 70° C.) at 75° C., thereby dissolving the behenyl alcohol in the fragrance and forming a mixture. The melting point range for the thus obtained mixture is from 10 to 50° C. The mixture is held at 60° C. to prevent it FROM solidifying prior to emulsification.

With the exception of using this encapsulation material (A), a microcapsule slurry with a solid fraction concentration of approximately 40% is prepared in the same manner as the Example 1.

### Example 3

### Production of Melamine Resin Membrane/Fragrance Microcapsules (in situ Polymerization Method)

An encapsulation material (A) is prepared by mixing 65% of the mint fragrance and 35% of paraffin wax (EMW-0003, manufactured by Nippon Seiro Co., Ltd., melting point: 50° C.) at 60° C., thereby dissolving the paraffin wax in the fragrance and forming a mixture. The melting point range for the thus obtained mixture is from 0 to 40° C. The mixture is held at 50° C. to prevent it solidifying prior to emulsification.

With the exception of using this encapsulation material (A), a microcapsule slurry with a solid fraction concentration of approximately 40% is prepared in the same manner as the Example 1.

### Example 4

### Production of Urea-Formalin Resin Membrane/Fragrance Microcapsules (in situ Polymerization Method)

10% of a urea resin monomer (reagent grade, manufactured by Nissan Chemical Industries, Ltd.), 2% of a resorcin resin monomer (reagent grade, manufactured by Mitsui Chemicals, Inc.), and 3% of an ethylene maleic anhydride resin (Scripset-520, manufactured by Monsanto Company) are dissolved in 85% of water, and the solution is adjusted to pH 3 using acetic acid.

50 parts of the thus obtained aqueous solution is heated to 60° C., 40 parts of the same encapsulation material as the example 1 is added and emulsified, and stirring is conducted for approximately 30 minutes, until oil droplets with an average particle size of 3 μm had been formed. To this emulsion is added 10 parts of formaldehyde, and stirring is then continued for 2 hours, thus generating a urea-formalin resin around the periphery of the encapsulation material, and forming a microcapsule slurry with a solid fraction concentration of approximately 40%.

### Example 5

### Scented Quick-Set Lithographic Ink

Offset Ink Base is combined with other ink components to produce a Quick-Set lithographic ink as follows:

| Ingredient | Weight % |
|---|---|
| Offset Ink Base | 50.0 |
| Quick Set Gel Vehicle | 12.5 |
| Quick Set Free Flow Vehicle | 7.5 |
| 12% Cobalt Drier | 1.0 |
| 6% Manganese Drier | 1.0 |
| Ink Oil (IBP 510 deg. F.) | 3.0 |
| Scented Microcapsule Slurry* | 25.0 |
| TOTAL | 100.0 |

*This material is produced in any one of Examples 1, 2, 3 or 4.

### Example 6

### Rub Resistant Ink

To the ink described in Example 5 is added a finely divided microcrystalline wax, polyethylene wax, Fisher-Tropsch wax, either alone or in combination with a finely divided polytetrafluorethylene polymer, is added to the ink to improve the dry rub resistance of the dried ink film. Additions of dry wax may be made from 0.5% to 3.0%. Additions of compounded waxes may be from 1.5% to 10%, depending on the wax compound used should not exceed 15.

### Example 7

### Hard Drying Ink

Offset Ink Base is combined with other ink components to produce a hard drying, high solids ink as follows:

| Ingredient | Weight % |
|---|---|
| Offset Ink Base | 50.0 |
| High Solids Gel Vehicle | 10.0 |
| High-solids Free Flow Vehicle | 10.0 |
| 12% Cobalt Drier | 1.0 |
| 6% Manganese Drier | 1.0 |
| Ink Oil (IBP 510 deg. F.) Litho Varnish | 3.0 |
| Scented Microcapsule Slurry* | 25.0 |
| TOTAL | 100.0 |

### Metal Decoration

An ink or coating may be applied to aluminum to make a beverage can with both scent and thermochromic attributes. The coating may be applied using conventional metal decorating equipment. The coating can be applied to any part of a can including the base or bottom, the side walls, neck, top surface, and the pull tab. The vehicle can be waterbased, solvent based, ultraviolet or radiation curable, heatset, two part epoxy, or one part epoxy but is not limited to these examples. The coating may also be prepared by using one epoxy coating for metal decorating, such as those sold by companies like Valspar or Watson Coatings. Thermochromic pigment loading is preferably between 1% and 30%, and most preferably is about 15%.

The aluminum stock may be roller coated, dipped, spray coated, or printed. The coating is prepared by adding a thermochromic to the vehicle or to a component in the finished vehicle. The thermochromic pigment may be dry or may contain between 0-50% moisture. The coating may be ready to use or be mixed with solvent, known by those skilled in the art, to a specific viscosity prior to use. It is preferable that the thermochromic microencapsulated pigment have adequate solvent resistance. The thermochromic microencapsulated pigment may be introduced to the vehicle using high speed dispersion with a beadmill, cowles blade mixer, 3 roll mill, or a sigma blade mixer. The coating may be made in a batch process or in a continuous process.

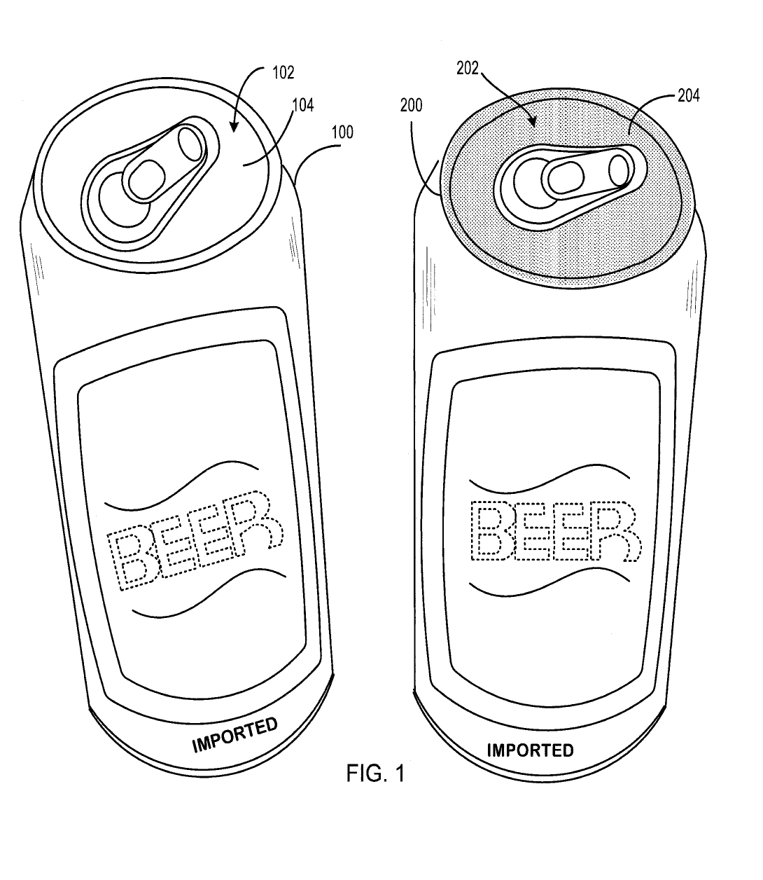

FIG. 1 compares identical beverage cans 100, 200, which differ in that can 100 is room temperature and can 200 is chilled. Lids 102, 202 are coated with epoxy-based thermochromic coatings 104, 204. As shown in FIG. 1, the relative darkness of lid 202 indicates that the beverage is sufficiently chilled to a recommended temperature for improved palatability. The tab may contain scented microcapsules to complement the beverage by imparting, for example, a cherry scent or a citrus scent.

The instrumentalities of this disclosure are taught by way of non-limiting example according to the specific formulations described below.

### Example 8

### Two Part Epoxy

### 15% Thermochromic Blue Pigment

15% Scented microcapsule slurry*
50% Epoxy Part A (Epoxy.com)
20% Hardener Part B (Epoxy.com)

### 100% Coating C

*This material may be as prepared in any of Examples 1, 2, 3 or 4.

Cut ‘Coating C’ with Xylene (1:1). Once cut with solvent, the coating may be applied by roller coating or sprayer, and has an open time of several hours.

### Example 9

### Heatset Epoxy

70% Clear Coating (an epoxy coating available from Watson Standard of Pittsburgh, Pa.)
20% Thermochromic Blue pigment
10% Scented microcapsule slurry*

### 100% Thermochromic Coating

*This material may be as prepared in any of Examples 1, 2, 3 or 4.

This coating may be cut with xylene (1:1) to a desired viscosity, applied using a roller coater, and baked for 5-18 seconds at 400° F.

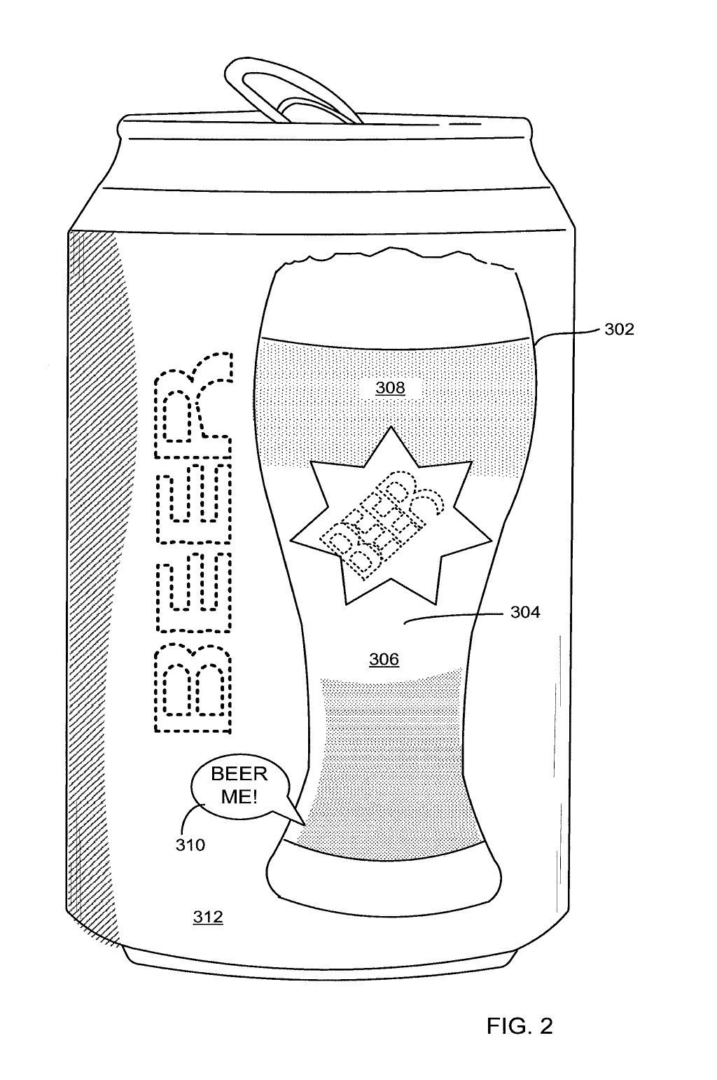

FIG. 2 shows a beverage can 300 that contains an image 302 of a glass that is half-full of beer. The image 302 is printed with a scented thermochromic ink, as described above, to provide a color change interface 304 corresponding to the approximate level of beer inside can 300. The image 302 is optionally but preferably provided with lime-scented microcapsules, such that the scent complements the organoleptic qualities of the beverage.

The image 302 is provided with a number of features that sense and inform a beverage drinker of the thermal quality of the beverage. The ink in region 306 has a yellow color phase when chilled to less than a first color transition temperature below that of beer which is perceptibly cooler than normal room temperature. The ink in region 308 is warmed above the first color transition temperature and so presents a different color, in this case a white background indicating that no beer is present. A “BEER ME!” message 310 is printed from two different inks each having approximately the same color transition temperature, which here is referred to as the second color transition temperature. The message 310 is normally hidden from view, matching the color of a background 312. Upon sufficient warming to a value above the second color transition temperature, the message 310 becomes visible to indicate that the beverage has warmed to a temperature where the organoleptic qualities of the beverage are less than optimal or may even begin to degrade. The second color transition temperature preferably differs from the first color transition temperature, such as by having a higher value. Thus, the sensed level indicator of interface 304 may more accurately depict a true liquid level with less regard for the organoleptic qualities of the beverage itself, while the message 310 is a truer indicator of organoleptic quality.

1. In a thermochromic ink that contains a vehicle mixed with microcapsules encapsulating a thermochromic system, the improvement comprising:
scented microcapsules.

2. The thermochromic ink of claim 1, wherein the scented microcapsules are different from the microcapsules encapsulating the thermochromic system.

3. The thermochromic ink of claim 1, wherein the scented microcapsules are the same as the microcapsules encapsulating the thermochromic system.

4. The thermochromic ink of claim 1, wherein the scented microcapsules utilize melamine-formaldehyde as the encapsulating material.

5. The thermochromic ink of claim 1, wherein the vehicle is an epoxy-based vehicle for use in metal deco applications.

6. A beverage can including an image formed using the thermochromic ink of claim 1.

7. The beverage can of claim 1, wherein the image is constructed and arranged to function as a liquid level indicator.
